(19) United States
(12) Patent Application Publication
(10) Pub. No.: US 2005/0076732 A1
(43) Pub. Date: Apr. 14, 2005

(54) Ball screw apparatus

(75) Inventor: Kazuo Miyaguchi, Gunma (JP)

Correspondence Address: SUGHRUE MION, PLLC, 2100 PENNSYLVANIA AVENUE, N.W., SUITE 800, WASHINGTON, DC, 20037, US

(73) Assignee: NSK LTD.

(21) Appl. No.: 10/927,038

(22) Filed: Aug. 27, 2004

(30) Foreign Application Priority Data
Aug. 28, 2003 (JP) P2003-209276

(51) Int. Cl. F16H 3/06

(52) U.S. Cl. 74/424.83

(57) ABSTRACT

A ball screw apparatus includes: a screw shaft having a first screw groove in a spiral shape at an outer peripheral face thereof; a nut having a second screw groove in correspondence with the first screw groove at an inner peripheral face thereof and screwed to the screw shaft; a number of balls rollably charged to an interval between the first screw groove and the second screw groove; a rolling bearing outwardly fitted on the nut; and a sleeve disposed between the nut and the rolling bearing.

### BACKGROUND OF THE INVENTION

1. Field of the Invention

The present invention relates to a ball screw apparatus used in a feed mechanism or the like of various apparatus, particularly relates to a type of ball screw apparatus for moving a screw shaft in an axial direction by rotating a nut.

2. Background Art

Hitherto, there have been known a ball screw apparatus of this kind as shown in, for example, FIG. 4. According to the ball screw apparatus 1, a screw shaft 3 having a screw groove 2 in a spiral shape on an outer peripheral face thereof and extending in an axial direction is screwed with a nut 6 having a screw groove 4 in a spiral shape in correspondence with the screw groove 2 on an inner peripheral face thereof.

The screw groove 4 of the nut 6 and the screw groove 2 of the screw shaft 3 are opposed to each other to form a loaded raceway in a spiral shape therebetween, and a number of balls 5 as rolling members are rollably charged to the loaded raceway. Further, by rotating the nut 6 via a pulley mechanism or the like, the screw shaft 3 is made to move in the axial direction via rolling of the balls 5.

Further, in the case of the ball screw apparatus of a ball circulating type as shown in the drawing, for example, a flat face 8a is formed at an outer peripheral portion of the nut 6. The flat face 8a is formed with a set of two pieces of holes 7 communicating to an interval of the two screw grooves 2, 4 to ride over the screw shaft 3, by fitting both ends of a circulating tube 8 substantially in a U-like shape as an example of a circulating part to the set of holes 7, the balls 5 revolving along the loaded raceway between the two screw grooves 2, 4 are scooped up from a midway of the loaded raceway by the circulating tube 8 to return to the original loaded raceway to thereby form a circulating circuit of the ball 5.

Meanwhile, according to the ball screw apparatus of a type of moving the screw shaft 3 in the axial direction by rotating the nut 6 as described above, as shown by FIG. 5 through FIG. 7, the nut 6 is rotated by outwardly fitting a plurality of rolling bearings 10 to the nut 6. According to the example, 5 pieces of the rolling bearings 10 are outwardly fitted to the nut 6, an inner ring of the rolling bearing 10 on one end side (right end side of FIG. 5) is brought into contact with a flange portion 6a of the nut 6, and an inner ring of the rolling bearing 10 on other side (left end side of FIG. 5) is pressed in the axial direction by a pressing lid 12 fixed to an end face of the nut 6 via a screw 11 or the like.

### SUMMARY OF THE INVENTION

However, according to the ball screw apparatus described above, when the plurality of rolling bearing 10 outwardly fitted directly to the nut 6 are fastened in the axial direction by the pressing lid 12 by fastening the screw 11, there is a concern that the screw groove 4 of then nut 6 is elastically deformed due to an axial force in accordance with a force of fastening the screw 11 to the nut 6. Such elastic deformation of the screw grove 4 might cause deterioration in operability of the ball screw apparatus, a fluctuation of a preload, and a heat generation because of an increased torque.

The invention has been carried out in order to resolve such a drawback and it is an object thereof to provide a ball screw apparatus capable of ensuring excellent operability and capable of preventing heat generation by increasing a torque.

The invention provides a ball screw apparatus, including: a screw shaft having a first screw groove in a spiral shape at an outer peripheral face thereof; a nut having a second screw groove in correspondence with the first screw groove at an inner peripheral face thereof and screwed to the screw shaft; a number of balls rollably charged to an interval between the first screw groove and the second screw groove; a rolling bearing outwardly fitted on the nut; and a sleeve disposed between the nut and the rolling bearing.

The ball screw apparatus may further include a circulating part provided at an outer peripheral portion of the nut to infinitely circulate the balls rolling at the interval between the first and second screw grooves. The sleeve has an opening portion disposed at a portion in correspondence with the circulating part.

The ball screw apparatus may further include a pressing lid fixed on one of the axial end portions of the sleeve. The sleeve has a flange portion at the other of the axial end portions thereof. The rolling bearing is pressed by the pressing lid and the flange portion in an axial direction of the screw shaft to be fixed therebetween.

### BRIEF DESCRIPTION OF THE DRAWINGS

The present invention may be more readily described with reference to the accompanying drawings:

FIG. 1 is an explanatory for explaining a ball screw apparatus according to an example of an embodiment of the invention.

FIG. 2 is a left side view of FIG. 1.

FIG. 3 is a right side view of FIG. 1.

FIG. 4 is a sectional view for explaining an example of a ball screw apparatus.

FIG. 5 is an explanatory view for explaining a conventional ball screw apparatus.

FIG. 6 is a left side view of FIG. 5.

FIG. 7 is a right side view of FIG. 5.

### DETAILED DESCRIPTION OF THE PREFERRED EMBODIMENTS

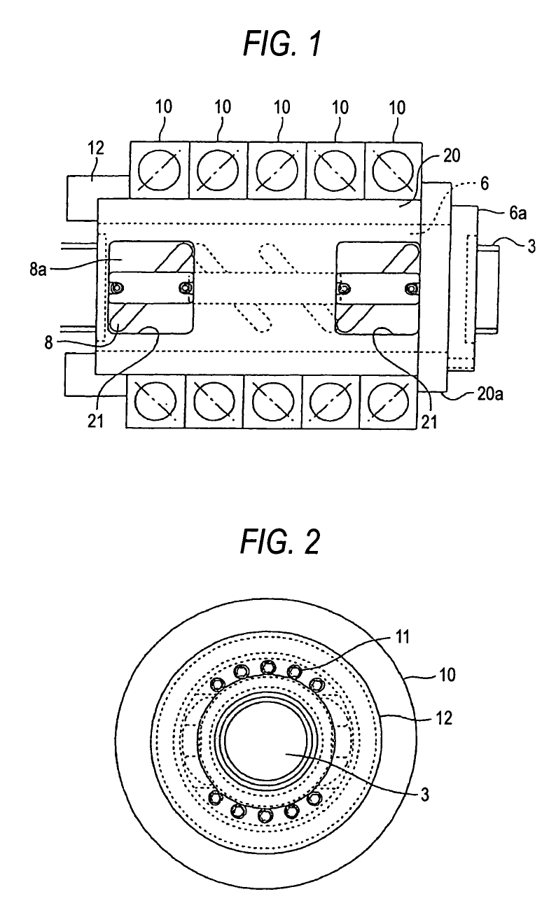

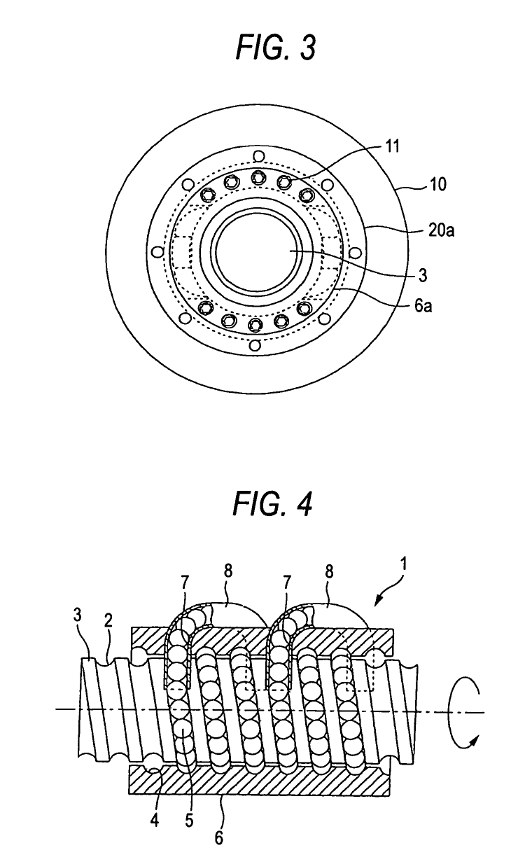

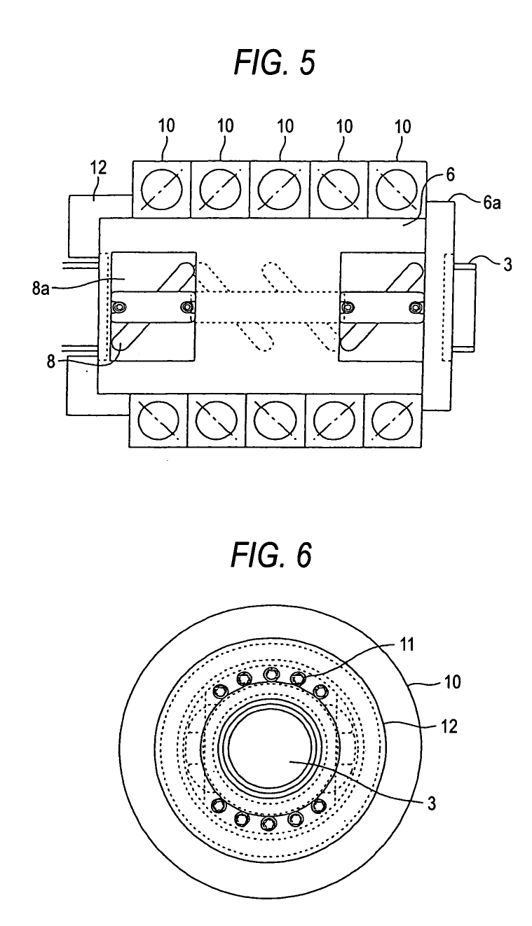

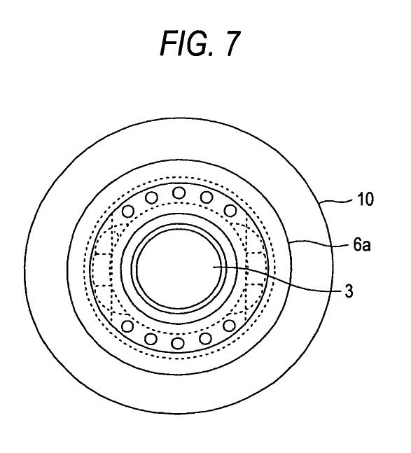

An explanation will be given of an embodiment of the invention in reference of the drawings as follows. FIG. 1 is an explanatory view for explaining a ball screw apparatus according to an example of an embodiment of the invention, FIG. 2 is a left side view of FIG. 1, and FIG. 3 is a right side view of FIG. 1. Further, portions duplicated with those of the ball screw apparatus explained in reference to FIG. 4 and FIG. 5 are attached with the same notations in the drawings and an explanation thereof will be omitted.

In the ball screw apparatus according to an example of the embodiment of the invention, as shown in FIG. 1 through FIG. 3, a plurality (5 pieces in the drawing) of the rolling bearings 10 are outwardly fitted to the nut 6 via a sleeve 20 to rotate the nut 6. The sleeve 20 is provided with an inner diameter face having a diameter equivalent to or more less lager than an outer diameter of the nut 6 and outwardly fitted to the nut 6. An end portion of the sleeve 20 on a side of the flange portion 6a of the nut 6 is provided with a flange portion 20a having a diameter larger than that of the flange portion 6a. The respective flange portions 6a, 20a are connected to each other via the screw 11 or the like.

Further, the inner ring of the rolling bearing 10 in the plurality of rolling bearings 10 outwardly fitted to the sleeve 20 on one end side (right end side of FIG. 1) is brought into contact with the flange portion 20a of the sleeve 20, and the inner ring of the rolling bearing 10 on other end side thereof is pressed by the pressing lid 12 fixed to an end face of the sleeve 20 via the screw 11 or like.

Further, a portion of the sleeve 20 in correspondence with the circulating tube 8 is formed with an opening portion 21 for integrating the circulating tube 8 and a dimension of an outer diameter of the sleeve 20 becomes substantially equal to or larger than a jump out diameter of the circulating tube 8.

Further, as a procedure of integrating the ball screw apparatus, for example, after outwardly fitting the sleeve 20 to the nut 6 and coupling the two flange portions 6a, 20a, a number of the ball 5 are charged to the interval between the screw groove 2 of the screw shaft 3 and the screw groove 4 of the nut 6. Successively, the circulating tube 8 is integrated from the opening portion 21 of the sleeve 20. Finally, the plurality of rolling bearings 10 are outwardly fitted to the sleeve 20 and the respective rolling bearings 10 are fastened in the axial direction by the pressing lid 12.

In this way, according to the embodiment, the plurality of rolling bearings 10 are outwardly fitted to the nut 6 via the sleeve 20. Therefore, when the plurality of rolling bearings 10 are fastened in the axial direction by the pressing lid 12 by fastening the nut 11, an axial force generated as the force of fastening the screw 11 is received by the sleeve 20. As a result, excellent operability of the ball screw apparatus can be ensured by preventing elastic deformation of the screw groove 4 of the nut 6. Heat generation due to the increased torque can also be prevented.

Further, according to the conventional structure, the force of fastening the rolling bearing 10 directly influences on the torque of the rolling bearing 10 such that as the force of fastening the rolling bearing 10 is increased, the torque of the rolling bearing 10 (nut 6) increases. However, according to the invention, since the force of fastening the rolling bearing 10 and the torque of the rolling bearing 10 (nut 6) are independent from each other, a fastening torque can be controlled to correspond to a requested torque of the rolling bearing 10, and the rolling bearing 10 can be fastened by a safe fastening force.

Further, the opening portion 21 for integrating the circulating tube 8 is formed at the portion of the sleeve 20 in correspondence with the circulating tube 8 and the dimension of the outer diameter of the sleeve 20 is made to be substantially equivalent to or larger than the jump out diameter of the circulating tube 8 and therefore, compact formation of the ball screw apparatus can be realized.

Further, the ball screw apparatus of the invention is not limited to the above-described embodiment but can pertinently be changed within the range not deviated from the gist of the invention.

For example, although according to the above-described embodiment, the circulating tube is adopted as an example of the circulating part, the invention is not limited thereto but the invention may be applied to a ball screw apparatus having a circulating frame or other circulating part.

As is apparent from the above-described explanation, according to the invention, the plurality of rolling bearings are outwardly fitted to the nut via the sleeve and therefore, elastic deformation of the screw groove of the nut can be prevented in fastening the plurality of rolling bearings. As a result, it is possible to have effects in ensuring excellent operability and in preventing a heat generation due to an incrase of the torque.

The invention also has an effect in achieving compact formation of the apparatus.

1. A ball screw apparatus, comprising:
a screw shaft having a first screw groove in a spiral shape at an outer peripheral face thereof;
a nut having a second screw groove in correspondence with the first screw groove at an inner peripheral face thereof and screwed to the screw shaft;
a number of balls rollably charged to an interval between the first screw groove and the second screw groove;
a rolling bearing outwardly fitted on the nut; and
a sleeve disposed between the nut and the rolling bearing.

2. The ball screw apparatus according to claim 1, further comprising:
a circulating part provided at an outer peripheral portion of the nut to infinitely circulate the balls rolling at the interval between the first and second screw grooves;
wherein the sleeve has an opening portion disposed at a portion in correspondence with the circulating part.

3. The ball screw apparatus according to claim 1, further comprising:
a pressing lid fixed on one of the axial end portions of the sleeve;
wherein the sleeve has a flange portion at the other of the axial end portions thereof; and
the rolling bearing is pressed by the pressing lid and the flange portion in an axial direction of the screw shaft to be fixed therebetween.
